(19) United States
(12) Patent Application Publication
(10) Pub. No.: US 2024/0069434 A1
(43) Pub. Date: Feb. 29, 2024

(54) METHOD AND APPARATUS FOR PARTICLE BEAM-INDUCED PROCESSING OF A DEFECT OF A MICROLITHOGRAPHIC PHOTOMASK

(71) Applicant: Carl Zeiss SMT GmbH, Oberkochen (DE)

(72) Inventors: Christian Rensing, Bensheim (DE); Michael Brendel, Aschaffenburg (DE); Michael Budach, Hanau (DE); Martin Guenter Reuss, Dieburg (DE)

(21) Appl. No.: 18/387,905

(22) Filed: Nov. 8, 2023

Related U.S. Application Data
(63) Continuation of application No. PCT/EP2022/066347, filed on Jun. 15, 2022.

(30) Foreign Application Priority Data
Jun. 17, 2021 (DE) 102021115736.6

(51) Int. Cl. G03F 1/74; G03F 1/80; G06T 7/00; G06T 7/136; G06T 7/60

(52) U.S. Cl. CPC G03F 1/74; G03F 1/80; G06T 7/0006; G06T 7/136; G06T 7/60; G06T 2207/10061; G06T 2207/30148

(57) ABSTRACT

A method for particle beam-induced processing of a defect of a microlithographic photomask, including the steps of:
a) providing an image of at least a portion of the photomask,
b) determining a geometric shape of a defect in the image as a repair shape, with the repair shape comprising a number n of pixels,
c) subdividing, in computer-implemented fashion, the repair shape into a number k of sub-repair shapes, with an i-th of the k sub-repair shapes having a number mᵢ of pixels, which are a subset of the n pixels of the repair shape,
d) providing an activating particle beam and a process gas at each of the mᵢ pixels of a first of the sub-repair shapes for the purposes of processing the first of the sub-repair shapes,
e) repeating step d) for the first of the sub-repair shapes over a number j of repetition cycles, and
f) repeating steps d) and e) for each further sub-repair shape.

### CROSS-REFERENCE TO RELATED APPLICATIONS

This application is a continuation of and claims priority under 35 U.S.C. § 120 from PCT Application No. PCT/EP2022/066347, filed on Jun. 15, 2022, which claims priority from German Application DE 10 2021 115 736.6, filed on Jun. 17, 2021. The entire contents of each of these priority applications are incorporated herein by reference.

### TECHNICAL FIELD

The present invention relates to a method and an apparatus for particle beam-induced processing of a defect of a microlithographic photomask.

### BACKGROUND

Microlithography is used for producing microstructured component elements, such as for example integrated circuits. The microlithography process is performed using a lithography apparatus, which has an illumination system and a projection system. The image of a photomask (reticle) illuminated by use of the illumination system is in this case projected by use of the projection system onto a substrate, for example a silicon wafer, which is coated with a light-sensitive layer (photoresist) and arranged in the image plane of the projection system, in order to transfer the mask structure to the light-sensitive coating of the substrate.

In order to attain small structure sizes and hence to increase the integration density of the microstructured components, use is increasingly being made of light having very short wavelengths, referred for example as deep ultraviolet (DUV) or extreme ultraviolet (EUV). DUV has a wavelength of 193 nm, for example, and EUV has a wavelength of 13.5 nm, for example.

In this case, the microlithographic photomasks have structure sizes ranging from a few nanometers to several 100 nm. The production of such photomasks is very complicated and therefore costly. In particular, this is the case because the photomasks have to be defect-free as it is otherwise not possible to ensure that a structure produced on the silicon wafer by use of the photomask exhibits the desired function. In particular, the quality of the structures on the photomask is decisive for the quality of the integrated circuits produced on the wafer by use of said photomask.

It is for this reason that microlithographic photomasks are checked for the presence of defects and found defects are repaired in a targeted manner. Typical defects include the lack of envisaged structures, for example because an etching process was not carried out successfully, or else the presence of non-envisaged structures, for example because an etching process proceeded too quickly or developed its effect at a wrong position. These defects can be remedied by targeted etching of excess material or targeted deposition of additional material at the appropriate positions; by way of example, this is possible in a very targeted manner by use of electron beam-induced processes (FEBIP, “focused electron beam induced processing”).

DE 10 2017 208 114 A1 describes a method for particle beam-induced etching of a photolithographic mask. In this case, a particle beam, in particular an electron beam, and an etching gas are provided at a site on the photolithographic mask to be etched. The particle beam activates a local chemical reaction between a material of the photolithographic mask and the etching gas, as a result of which material is locally ablated from said photolithographic mask.

It has been determined for large-area defects that the composition of the provided process gas, e.g., of the etching gas, may disadvantageously change with increasing size of the defect. This can severely impair a processing of the defect. By way of example, an etching rate may reduce significantly on account of a disadvantageous gas composition, and so a defect cannot be removed completely or can only be removed completely with a higher electron beam dose (that is to say with a longer etching duration, for example). Against this background, it is an aspect of the present invention to provide an improved method and an improved apparatus for particle beam-induced processing of a defect of a microlithographic photomask.

### SUMMARY

Accordingly, a method is proposed for particle beam-induced processing of a defect of a microlithographic photomask. The method includes the steps of:
a) providing an image of at least a portion of the photomask,
b) determining a geometric shape of a defect in the image as a repair shape, with the repair shape comprising a number n of pixels,
c) subdividing, in computer-implemented fashion, the repair shape into a number k of sub-repair shapes, with an i-th of the k sub-repair shapes having a number mᵢ of pixels, which are a subset of the n pixels of the repair shape,
d) providing an activating particle beam and a process gas at each of the mᵢ pixels of a first of the sub-repair shapes for the purposes of processing the first of the sub-repair shapes,
e) repeating step d) for the first of the sub-repair shapes over a number j of repetition cycles, and
f) repeating steps d) and e) for each further sub-repair shape.

In particular, each of n, k, mᵢ and j is an integer greater than or equal to two. Moreover, i is an integer specifying a counter running from 1 to k.

The repair shape is subdivided into the plurality of sub-repair shapes, and hence a processing time for one of the sub-repair shapes is shorter than that of the entire repair shape. As a result, a gas composition of the process gas which is required and/or optimal for processing of the defect can be better ensured during the processing of a sub-repair shape. As a result, the defect can be processed better. By way of example, the proposed method renders it possible to also process large-area repair shapes and/or repair shapes having many pixels using an advantageous and/or optimal gas composition of the process gas.

The processing of the defect comprises, in particular, an etching of the defect, within the scope of which material is locally ablated from the photomask, or a deposition of material on the photomask in the region of the defect. By way of example, the proposed method allows a superfluous structure in the region of the defect to be better etched away, or a missing structure in the region of the defect can be better augmented.

The image of the at least one portion of the photomask is recorded by use of a scanning electron microscope (SEM), for example. By way of example, the image of the at least one portion of the photomask has a spatial resolution of the order of a few nanometers. The image may also be recorded using a scanning probe microscope (SPM), such as, e.g., an atomic force microscope (AFM) or a scanning tunnelling microscope (STM).

The method may in particular include a step of capturing the image of the at least one portion of the photomask by use of a scanning electron microscope and/or a scanning probe microscope.

By way of example, the microlithographic photomask is a photomask for an EUV lithography apparatus. In this case, EUV stands for “extreme ultraviolet” and denotes a wavelength of the working light of between 0.1 nm and 30 nm, in particular 13.5 nm. Within an EUV lithography apparatus, a beam shaping and illumination system is used to guide EUV radiation onto a photomask (also referred to as “reticle”), which in particular is in the form of a reflective optical element (reflective photomask). The photomask has a structure which is imaged onto a wafer or the like in a reduced fashion by use of a projection system of the EUV lithography apparatus.

By way of example, the microlithographic photomask can also be a photomask for a DUV lithography apparatus. In this case DUV stands for “deep ultraviolet” and denotes a wavelength of the working light of between 30 nm and 250 nm, in particular 193 nm or 248 nm. Within a DUV lithography apparatus, a beam shaping and illumination system is used to guide DUV radiation onto a photomask, which in particular is in the form of a transmissive optical element (transmissive photomask). The photomask has a structure which is imaged onto a wafer or the like in a reduced fashion by use of a projection system of the DUV lithography apparatus.

By way of example, the microlithographic photomask comprises a substrate and a structure formed on the substrate by way of a coating. By way of example, the photomask is a transmissive photomask, in the case of which the pattern to be imaged is realized in the form of an absorbing (i.e., opaque or partly opaque) coating on a transparent substrate. Alternatively, the photomask can also be a reflective photomask, for example, especially for use in EUV lithography.

By way of example, the substrate comprises silicon dioxide (SiO2), for example fused quartz. By way of example, the structured coating comprises chromium, chromium compounds, tantalum compounds and/or compounds made of silicon, nitrogen, oxygen and/or molybdenum. The substrate and/or the coating may also comprise other materials.

In the case of a photomask for an EUV lithography apparatus, the substrate may comprise an alternating sequence of molybdenum and silicon layers.

Using the proposed method, it is possible to identify, locate and repair a defect of a photomask, in particular a defect of a structured coating of said photomask. In particular, a defect is an (e.g., absorbing or reflecting) coating of the photomask that has been applied incorrectly to the substrate. The method can be used to augment the coating at sites on the photomask where it is lacking. Furthermore, the coating can be removed using the method from sites on the photomask where it had been applied incorrectly.

To this end, a geometric shape of the defect is determined in the recorded image of the at least one portion of the photomask. By way of example, a two-dimensional, geometric shape of the defect is determined. The determined geometric shape of the defect is referred to below as a so-called repair shape.

n pixels are defined in the repair shape for the particle beam-induced processing of said repair shape. Over the course of steps d) to f) of the method, the particle beam is directed at each of the n pixels of the repair shape. In particular, an intensity maximum of the electron beam is directed at each center of each of the n pixels. Expressed differently, the n pixels of the repair shape represent a raster, in particular a two-dimensional raster, of the repair shape for the particle beam-induced processing. By way of example, the n pixels of the repair shape correspond to areas of incidence of the particle beam during the particle beam-induced processing of the defect. By way of example, a pixel size is chosen in such a way that an intensity distribution of an electron beam that is directed at a center of a pixel drops to a predetermined intensity at the edge of said pixel on account of the electron beam's Gaussian intensity distribution. The predetermined intensity may correspond to a drop to half of the intensity maximum or else a drop to any other fraction of the intensity maximum of the electron beam. By way of example, a pixel size and/or an electron beam full width at half maximum is in the subnanometer range or of the order of a few nanometers.

By way of example, the process gas is a precursor gas and/or an etching gas. By way of example, the process gas can be a mixture of a plurality of gaseous components, that is to say a process gas mixture. By way of example, the process gas can be a mixture of a plurality of gaseous components, of which each only has a certain molecule type.

In particular, alkyl compounds of main group elements, metals or transition elements can be considered as precursor gases suitable for the deposition or for growing of elevated structures. Examples thereof are (cyclopentadienyl)trimethylplatinum (CpPtMe₃ Me=CH₄), (methylcyclopentadienyl)trimethylplatinum (MeCpPtMe₃), tetramethyltin (SnMe₄), trimethylgallium (GaMe₃), ferrocene (Cp₂Fe), bisarylchromium (Ar₂Cr), and/or carbonyl compounds of main group elements, metals or transition elements, such as, for example, chromium hexacarbonyl (Cr(CO)₆), molybdenum hexacarbonyl (Mo(CO)₆), tungsten hexacarbonyl (W(CO)₆), dicobalt octacarbonyl (Co₂(CO)₈), triruthenium dodecacarbonyl (Ru₃(CO)₁₂), iron pentacarbonyl (Fe(CO)₅), and/or alkoxide compounds of main group elements, metals or transition elements, such as, for example, tetraethoxysilane (Si(OC₂H₅)₄), tetraisopropoxytitanium (Ti(OC₃H₇)₄), and/or halide compounds of main group elements, metals or transition elements, such as, for example, tungsten hexafluoride (WF₆), tungsten hexachloride (WCl₆), titanium tetrachloride (TiCl₄), boron trifluoride (BF₃), silicon tetrachloride (SiCl₄), and/or complexes comprising main group elements, metals or transition elements, such as, for example, copper bis(hexafluoroacetylacetonate) (Cu(C₅F₆HO₂)₂), dimethylgold trifluoroacetylacetonate (Me₂Au(C₅F₃H₄O₂)), and/or organic compounds such as carbon monoxide (CO), carbon dioxide (CO₂), aliphatic and/or aromatic hydrocarbons, and the like.

By way of example, the etching gas may comprise: xenon difluoride (XeF₂), xenon dichloride (XeCl₂), xenon tetrachloride (XeCl₄), steam (H₂O), heavy water (D₂O), oxygen (O₂), ozone (O₃), ammonia (NH₃), nitrosyl chloride (NOCl) and/or one of the following halide compounds: XNO, XONO₂, X₂O, XO₂, X₂O₂, X₂O₄, X₂O₆, where X is a halide. Further etching gases for etching one or more of the deposited test structures are specified in the applicant's U.S. patent application Ser. No. 13/103,281, filed on May 9, 2011, and issued as U.S. Pat. No. 9,721,754 on Aug. 1, 2017.

The process gas may contain further additive gases, for example oxidizing gases such as hydrogen peroxide (H₂O₂), nitrous oxide (N₂O), nitrogen oxide (NO), nitrogen dioxide (NO₂), nitric acid (HNO₃) and other oxygen-containing gases and/or halides such as chlorine (Cl₂), hydrogen chloride (HCl), hydrogen fluoride (HF), iodine (I₂), hydrogen iodide (HI), bromine (Br₂), hydrogen bromide (HBr), phosphorus trichloride (PCl₃), phosphorus pentachloride (PCl₅), phosphorus trifluoride (PF₃) and other halogen-containing gases and/or reducing gases, such as hydrogen (H₂), ammonia (NH₃), methane (CH₄) and other hydrogen-containing gases. Said additive gases can be used for example for etching processes, as buffer gases, as passivating media and the like.

By way of example, the activating particle beam is provided with the aid of an apparatus which may comprise: a particle beam source for producing the particle beam: a particle beam guiding device (e.g., scanning unit) configured to direct the particle beam at a pixel mᵢ of the respective sub-repair shape of the photomask; a particle beam shaping device (e.g., electron or beam optics) configured to shape, in particular focus, the particle beam; at least one storage container configured to store the process gas or at least a gaseous component of the process gas: at least one gas provision device configured to provide the process gas or the at least one gaseous component of the process gas with a predetermined gas quantity flow rate to the pixel mᵢ of the respective sub-repair shape.

The activating particle beam for example comprises an electron beam, an ion beam and/or a laser beam.

By way of example, an electron beam is provided with the aid of a modified scanning electron microscope. By way of example, the image of the at least one portion of the photomask is recorded using the same modified scanning electron microscope that provides the activating electron beam.

The activating particle beam activates, in particular, a local chemical reaction between a material of the photomask and the process gas, which leads to a local deposition of material on the photomask from the gaseous phase or a local transition of material of the photomask into the gaseous phase.

The activating particle beam is provided successively at each of the mᵢ pixels of a respective sub-repair shape, for example by use of the particle beam guiding device. In step d) of the method, the activating particle beam remains on each of the mᵢ pixels for a predetermined dwell time. By way of example, the dwell time is 100 ns.

In particular, steps d) to f) are carried out without interruption in a single repair sequence. That is to say, the particle beam, especially after having been provided at the last pixel of the first (or a further one) of the sub-repair shapes, is immediately provided at a first pixel of the sub-repair shape to be processed next.

According to an embodiment, the activating particle beam and the process gas are solely provided at each of the mᵢ pixels of the first of the sub-repair shapes in step d).

Expressed differently, the activating particle beam and the process gas are in step d) only provided at the pixels of the first sub-repair shape and not at pixels of the further sub-repair shapes. One could also say that the sub-repair shapes are processed successively in steps d) to f).

According to a further embodiment, the repair shape is subdivided in step c) into the number k of sub-repair shapes on the basis of a threshold.

By way of example, the repair shape is subdivided into the plurality of sub-repair shapes in such a way that the sub-repair shapes all have the same size and the same number of pixels mᵢ. By way of example, the repair shape can also be subdivided into the plurality of sub-repair shapes in such a way that the pixel numbers mᵢ of the sub-repair shapes deviate from one another by less than 30%, 20%, 10%, 5%, 3% and/or 1%.

By way of example, the repair shape is subdivided into the plurality of sub-repair shapes on the basis of the threshold, in such a way that a decision as to whether or not step c) is carried out is made on the basis of the threshold. Expressed differently, the repair shape is subdivided into the plurality of sub-repair shapes on the basis of the threshold, for example in such a way that a subdivision into the plurality of sub-repair shapes is carried out above the threshold while there is no subdivision of the repair shape below the threshold.

By way of example, the repair shape is subdivided into the plurality of sub-repair shapes, in such a way that the number k of sub-repair shapes, into which the repair shape is subdivided, is determined on the basis of the threshold.

The threshold may also contain a first (e.g. upper) and a second (e.g. lower) threshold (i.e. a parameter range).

According to a further embodiment, the threshold is an empirically determined value, which is determined before step a).

As a result, the threshold can be defined before the application of the method for particle beam-induced processing of the defect. By way of example, the threshold may be determined in advance and within the scope of a separate method for determining the threshold by a manufacturer of an apparatus for carrying out the method. As a result, the method for processing a defect of a photomask can be carried out more easily for a user.

According to a further embodiment, the particle beam-induced processing comprises an etching of the defect or a deposition of material on the defect and the threshold is determined from empirical values of an etching rate or a deposition rate on the basis of a number n of pixels of a repair shape.

As a result, the attainment of a desired etching rate or deposition rate can be ensured in the case of a defect of a photomask that corresponds to a repair shape with n pixels.

According to a further embodiment, the threshold is an empirically determined value which is determined on the basis of parameters which are selected from a group comprising: the number n of pixels of the repair shape, a size of the pixels, an area of incidence of the particle beam, a dwell time of the activating particle beam on a respective pixel, a gas quantity flow rate with which the process gas is provided, a composition of the process gas and a gas quantity flow rate ratio of various gaseous components of the process gas.

This can ensure that, in particular, a subdivision of the repair shape into the plurality of sub-repair shapes is carried out in this way and whenever the lack of such a subdivision renders a composition, gas quantity and/or density of the process gas at the pixels of the repair shape to be processed disadvantageous at the time when a certain pixel should be processed.

In particular, the threshold is an empirically determined threshold, which is determined in such a way that a defect of a photomask can be repaired, for example etched, by the particle beam-induced processing to at least a predetermined quality. By way of example, the quality of the repair is determined by determining the smoothness of the repair site (e.g. smoothness of an etching), the width of repair edges (e.g. etching edges), the speed of the repair (e.g. etching) and/or an etching rate or deposition rate.

In particular, a gas quantity flow rate is a volumetric flow rate or flow rate which specifies the volume of the process gas that is transported through a defined cross-section, e.g. a valve of a gas provision unit, per unit time. By way of example, the gas quantity flow rate is defined by setting the temperature of the process gas. By way of example, the temperature of the process gas is set to a temperature in the range between −40° C. and +20° C.

The dwell time is the duration for which the activating particle beam is directed at one of the mᵢ pixels of a sub-repair shape for the purposes of initiating a local reaction (chemical reaction, etching reaction and/or material deposition reaction) at the photomask at the location of this pixel.

According to a further embodiment, the repair shape is subdivided into the plurality of sub-repair shapes with the aid of a Voronoi approach.

A Voronoi approach or Voronoi diagram facilitates easy subdivision of the geometric shape of the defect, i.e. the repair shape, into the sub-repair shapes. In particular, a defect with an irregular shape and hence a repair shape with an irregular shape can easily be decomposed into sub-repair shapes.

According to a further embodiment, the sub-repair shapes are determined as Voronoi regions starting from Voronoi centers in step c). Each sub-repair shape comprises the pixel of the repair shape corresponding to the associated Voronoi center and all pixels of the repair shape that are arranged closer to the associated Voronoi center than any other Voronoi center of the repair shape.

In particular, a distance between Voronoi centers is predetermined in step c) on the basis of the threshold, and the Voronoi centers are determined on the basis of the predetermined distance. By way of example, as a result, the Voronoi centers are defined in the repair shape in such a way that they are distributed uniformly over the repair shape.

According to a further embodiment, the repair shape is subdivided into the plurality of sub-repair shapes in such a way that the mᵢ pixels of a respective sub-repair shape have the same distance from one another in a scanning direction.

By way of example, the repair shape is a two-dimensional geometric shape that defines an XY-plane. By way of example, the n pixels of the repair shape are arranged in the X-direction and Y-direction. By way of example, the particle beam is guided in the X-direction and the Y-direction with the aid of a particle beam guiding device (scanning unit). By way of example, a scanning direction corresponds to the X-direction and/or the Y-direction.

What the pixels of a respective sub-repair shape having the same distance from one another in the scanning direction avoids is that, during scanning, the particle beam needs to be guided over gaps in the sub-repair shape, i.e. regions outside of the sub-repair shape, while a sub-repair shape is processed.

According to a further embodiment, the repair shape comprises at least two spaced apart regions. Furthermore, the repair shape is subdivided into the plurality of sub-repair shapes in such a way that each sub-repair shape comprises at most one of the at least two spaced apart regions.

As a result, it is possible to avoid the particle beam having to be moved back and forth between non-contiguous regions, that is to say spaced apart regions, during the processing of a sub-repair shape. This is especially advantageous since a sub-repair shape is processed by use of the particle beam over a number j of repetition cycles, which may be of the order of 100, 1000, 10 000, 100 000 or one million.

According to a further embodiment, the method comprises the following step before step d): calculating a sequence in which the activating particle beam is successively provided at the mᵢ pixels of the first of the sub-repair shapes such that a depletion of the process gas by way of a chemical reaction activated by the activating particle beam is implemented uniformly over the sub-repair shape.

In particular, line-by-line scanning of the mᵢ pixels of the sub-repair shape can be avoided.

According to a further embodiment, the sequence in which steps d) and e) are carried out in step f) for the further sub-repair shapes differs from a row-by-row and/or column-by-column sequence and/or is randomly distributed.

In particular, the sequence in which the sub-repair shapes are processed by use of steps d) and e) differs from a row-by-row and/or column-by-column sequence and/or is randomly distributed.

According to a further embodiment, the repair shape is subdivided in a number h of mutually different subdivisions into sub-repair shapes in step c). Furthermore, steps d) to f) are carried out for each of the h subdivisions.

This can avoid uneven processing of the defect at boundaries between the sub-repair shapes. In this case, h is an integer greater than or equal to two.

By way of example, the first sub-repair shapes of all h subdivisions can overlap with one another, the second sub-repair shapes of all h subdivisions can overlap with one another, etc. That is to say, the i-th sub-repair shapes of all h subdivisions can overlap with one another, for i=1 to k.

According to a further embodiment, steps d) to f) are carried out for each of the h subdivisions over a number g of repetition cycles, where g is less than j, and/or over a number j/h of repetition cycles.

As a result, the total number j of repetition cycles can be subdivided among the h subdivisions. In this case, g is an integer greater than or equal to two.

According to a further embodiment, the number h of subdivisions differ from one another by way of a displacement, in particular a lateral displacement, of boundaries of their sub-repair shapes relative to the repair shape.

A calculation of further subdivisions of the repair shape can be realized particularly easily in this way.

According to a further embodiment, steps d) to f) are repeated over a number p of repetition cycles, where p is an integer greater than or equal to two.

As a result of a defect not being repaired in full but only in part during one iteration of steps d) to f) and a complete repair of the defect only being achieved by the number p of repetition cycles, non-uniform processing of the defect at boundaries between the sub-repair shapes can be avoided. This embodiment represents an alternative to using a number h of mutually different subdivisions, or can be applied in addition thereto.

According to a further aspect, an apparatus is proposed for particle beam-induced processing of a defect of a microlithographic photomask. The apparatus comprises:
means for providing an image of at least a portion of a photomask,
a computing apparatus for determining a geometric shape of a defect in the image as a repair shape, with the repair shape comprising a number n of pixels and being configured to subdivide the repair shape into a plurality of sub-repair shapes in computer-implemented fashion, and
means for providing an activating particle beam and a process gas at each pixel of every sub-repair shape over a number j of repetition cycles for processing the respective sub-repair shape.

According to a further aspect, a computer program product is proposed, said computer program product comprising instructions which, when executed by a computing apparatus for controlling an apparatus for particle beam-induced processing of a defect of a microlithographic photomask, prompt the apparatus to carry out the method steps according to any one of Claims 1 to 13.

A computer program product, such as e.g. a computer program means, can be provided or supplied, for example, as a storage medium, such as e.g. a memory card, a USB stick, a CD-ROM, a DVD, or else in the form of a downloadable file from a server in a network. By way of example, in a wireless communications network, this can be effected by transferring an appropriate file with the computer program product or the computer program means.

Each of the units mentioned above and below, for example the computing apparatus, the control device, the determination device, the subdivision device, can be implemented in hardware and/or software. In the case of an implementation as hardware, the corresponding unit can be embodied as an apparatus or as part of an apparatus, for example as a computer or as a microprocessor. By way of example, the apparatus may comprise a central processing unit (CPU), a graphical processing unit (GPU), a programmable hardware logic (e.g., a field-programmable gate array. FPGA), an application-specific integrated circuit (ASIC) or the like. Moreover, the one or more units may be implemented together in a single hardware apparatus, and they can for example share a memory, interfaces and the like. The units can also be realized in separate hardware components.

According to a further aspect, a method for determining a threshold is proposed. The determined threshold serves to subdivide a repair shape on the basis of the threshold into a number k of sub-repair shapes during particle beam-induced processing of a defect of a microlithographic photomask. The method comprises the steps of:
i) particle beam-induced processing of a first test defect of a photomask using predetermined processing parameters, the first test defect having a first size,
ii) determining a quality of the processing of the first test defect,
iii) repeating steps i) and ii) for modified processing parameters until processing parameters are determined, for which the determined quality is better than or equal to a predetermined quality,
iv) particle beam-induced processing of further test defects of the photomask using the determined processing parameters, with the further test defects each having a size that differs from the sizes of the other further test defects and from the size of the first test defect,
v) determining the quality of the processing for each further test defect, and
vi) determining the threshold on the basis of the quality determined for the first and the further test defects.

The predetermined and determined processing parameters for example comprise a dwell time of an electron beam on a pixel (for example 100 ns, 10 ns or a few μs); a pause during which no pixel is “exposed” by the electron beam in order to ensure that sufficient adsorbed process gas is present at the surface near the repair site again (by way of example a value between 100 μs and 5000 μs): a type of guidance (scanning) of the electron beam over the pixels of the repair shape (e.g. line scan, serpentine scan, randomized homing in on the pixels and/or incremental homing in on the pixels) and/or a gas quantity flow rate of the process gas (by way of example, the gas quantity flow rate is defined by setting the temperature of the process gas, the temperature for example being between −40° C. and +20° C.).

By way of example, the quality of the repair is determined by determining the smoothness of the repair site (e.g. smoothness of an etching or a deposited material), the width of repair edges (e.g. etching edges or deposited edges), the speed of the repair (e.g. etching or depositing) and/or an etching rate or deposition rate. By way of example, the predetermined quality is a predetermined value of the smoothness of the repair site, a width of repair edges, a repair speed, an etching rate and/or a deposition rate.

The features and advantages described in relation to the method for particle beam-induced processing apply accordingly to the apparatus, the computer program product and the method for determining a threshold, and vice versa.

“A(n); one” in the present case should not necessarily be understood to be restrictive to exactly one element. Rather, a plurality of elements, such as, for example, two, three or more, can also be provided. Any other numeral used here, too, should not be understood to the effect that there is a restriction to exactly the stated number of elements. Rather, numerical deviations upwards and downwards are possible, unless indicated to the contrary.

Further possible implementations of the invention also comprise not explicitly mentioned combinations of any features or embodiments that are described above or below with respect to the exemplary embodiments. In this case, a person skilled in the art will also add individual aspects as improvements or supplementations to the respective basic form of the invention.

Further advantageous refinements and aspects of the invention are the subject matter of the dependent claims and also of the exemplary embodiments of the invention described below. In the text that follows, the invention will be explained in more detail on the basis of preferred embodiments with reference to the accompanying figures.

### BRIEF DESCRIPTION OF DRAWINGS

FIG. 1 schematically shows a detail of a microlithographic photomask having a defect in a structured coating according to one embodiment:

FIG. 2 shows an apparatus for particle beam-induced processing of the defect of the photomask from FIG. 1 according to one embodiment;

FIG. 3 shows a further example of a defect of the photomask from FIG. 1, with a geometric shape of the defect being subdivided into a plurality of sub-repair shapes:

FIG. 4 shows a magnified detail of FIG. 3;

FIG. 5 shows a view similar to FIG. 3, with the geometric shape of the defect being subdivided into a plurality of sub-repair shapes by two mutually different subdivisions;

FIG. 6 shows a further example of a defect of the photomask from FIG. 1;

FIG. 7 shows a further example of a defect of the photomask from FIG. 1:

FIG. 8 shows a flowchart of a method for particle beam-induced processing of a defect of the photomask of FIG. 1 according to one embodiment;

FIG. 9 shows a flowchart of a method for determining a threshold according to one embodiment, with the threshold determined in the process being able to be applied in the method of FIG. 8;

FIG. 10 shows an image of five repaired test defects, which are repaired and evaluated in the method of FIG. 9: and

FIG. 11 shows a diagram of an etching rate as a function of a defect size of the test defects from FIG. 10.

### DETAILED DESCRIPTION

Unless indicated to the contrary, elements that are the same or functionally the same have been provided with the same reference signs in the figures. It should also be noted that the illustrations in the figures are not necessarily true to scale.

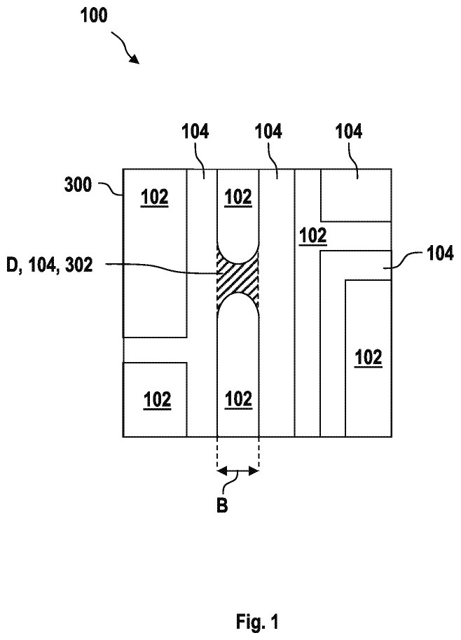

FIG. 1 schematically shows a detail of a microlithographic photomask 100. In the example shown, the photomask 100 is a transmissive photolithographic mask 100. The photomask 100 comprises a substrate 102. The substrate 102 is optically transparent, especially at the wavelength with which the photomask 100 is exposed. By way of example, a material of the substrate 102 comprises fused quartz.

A structured coating 104 (pattern elements 104) has been applied to the substrate 102. In particular, the coating 104 is a coating made of an absorbing material. By way of example, a material of the coating 104 comprises a chromium layer. By way of example, a thickness of the coating 104 ranges from 50 nm to 100 nm. A structure size B of the structure formed by the coating 104 on the substrate 102 of the photomask 100 may differ at various positions of the photomask 100. By way of example, the width B of a region is plotted as structure size in FIG. 1. By way of example, the structure size B lies in a region of 20 to 200 nm. The structure size B may also be greater than 200 nm, for example be of the order of micrometers.

Other materials to those mentioned may also be used for the substrate and the coating in other examples. Furthermore, the photomask 100 could also be a reflective photomask rather than a transmissive photomask. In this case, a reflecting layer is applied instead of an absorbing layer 104.

Occasionally, defects D can arise during the production of photomasks, for example because etching processes do not run exactly as intended. In FIG. 1, such a defect D is represented by hatching. This is excess material since the coating 104 was not removed from this region even though the two coating regions 104 next to one another are envisaged as separate in the template for the photomask 100. One could also say that the defect D forms a web. In this case, a size of the defect D corresponds to the structure size B. Other defects which are smaller than the structure size B, for example of the order of 5 to 20 nm, are also known. To ensure that a structure produced in a lithography apparatus using the photomask has the desired shape on a wafer and hence the semiconductor component produced in this way fulfils the desired function, it is necessary to repair defects, such as the defect D shown in FIG. 1 or else other defects. In this example it is necessary to remove the web in a targeted manner, for example by particle beam-induced etching.

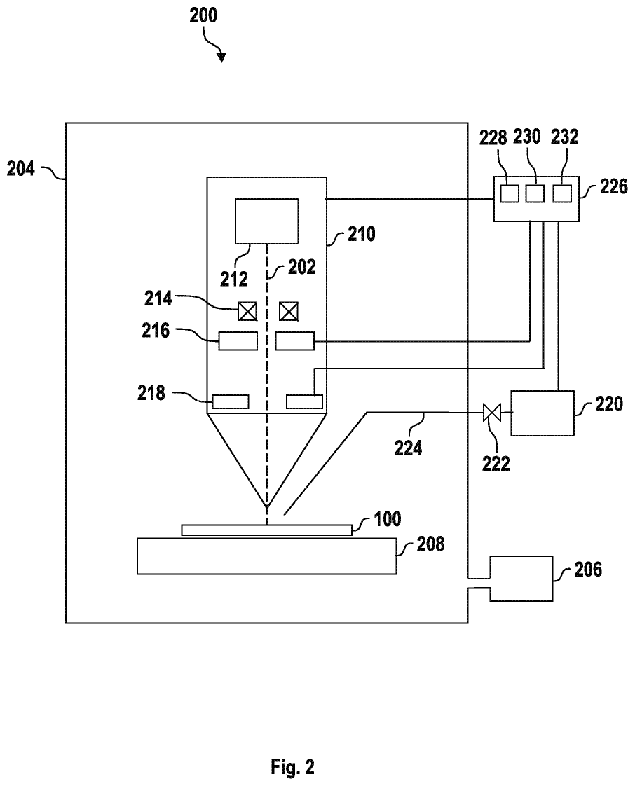

FIG. 2 shows an apparatus 200 for particle beam-induced processing of a defect of a microlithographic photomask, for example the defect D of the photomask 100 from FIG. 1. FIG. 2 shows a schematic section through a few components of the apparatus 200 which can be used for particle beam-induced repairing, in this case etching, of the defect D of the photomask 100. Moreover, the apparatus 200 can also be used for imaging the photomask, in particular the structured coating 104 of the mask 100 and of the defect D before, during and after the implementation of a repair process.

The apparatus 200 shown in FIG. 2 represents a modified scanning electron microscope 200. In this case, a particle beam 202 in the form of an electron beam 202 is used to repair the defect D. The use of an electron beam 202 as activating particle beam has the advantage that the electron beam 202 substantially cannot damage, or can only slightly damage, the photomask 100, in particular the substrate 102 thereof.

A laser beam for activating a local particle beam-induced repair process for the photomask 100 can be used instead of the electron beam 202 or in addition to the electron beam 202 in embodiments (not shown in FIG. 2). Further, instead of an electron beam and/or a laser beam, it is possible to use an ion beam, an atom beam and/or a molecule beam for activating a local chemical reaction (not shown in FIG. 2).

The apparatus 200 is largely arranged in a vacuum housing 204, which is kept at a certain gas pressure by a vacuum pump 206.

By way of example, the apparatus 200 is a repair tool for microlithographic photomasks, for example for photomasks for a DUV or EUV lithography apparatus.

A photomask 100 to be processed is arranged on a sample stage 208. By way of example, the sample stage 208 is configured to set the position of the photomask 100 in three spatial directions and in three axes of rotation with an accuracy of a few nanometers.

The apparatus 200 comprises an electron column 210. The electron column 210 comprises an electron source 212 for providing the activating electron beam 202. Furthermore, the electron column 210 comprises electron or beam optics 214. The electron source 212 produces the electron beam 202 and the electron or beam optics 214 focus the electron beam 202 and direct the latter to the photomask 100 at the output of the column 210. The electron column 210 moreover comprises a deflection unit 216 (scanning unit 216) which is configured to guide, i.e. scan, the electron beam 202 over the surface of the photomask 100.

The apparatus 200 furthermore comprises a detector 218 for detecting the secondary electrons and/or backscattered electrons produced at the photomask 100 by the incident electron beam 202. By way of example, as shown, the detector 218 is arranged around the electron beam 202 in ring-shaped fashion within the electron column 210. As an alternative and/or in addition to the detector 218, the apparatus 200 may also contain other/further detectors for detecting secondary electrons and/or backscattered electrons (not shown in FIG. 2).

Moreover, the apparatus 200 may comprise one or more scanning probe microscopes, for example atomic force microscopes, which can be used to analyse the defect D of the photomask 100 (not shown in FIG. 2).

The apparatus 200 furthermore comprises a gas provision unit 220 for supplying process gas to the surface of the photomask 100. By way of example, the gas provision unit 220 comprises a valve 222 and a gas line 224. The electron beam 202 directed at a location on the surface of the photomask 100 by the electron column 210 can carry out electron-beam induced processing (EBIP) in conjunction with the process gas supplied by the gas provision unit 220 from the outside via the valve 222 and the gas line 224. In particular, said processes comprise a deposition and/or an etching of material.

The apparatus 200 moreover comprises a computing apparatus 226, for example a computer, having a control device 228, a determination device 230 and a subdivision device 232. In the example of FIG. 2, the computing apparatus 226 is arranged outside of the vacuum housing 204.

The computing apparatus 226, in particular the control device 228, serves to control the apparatus 200. In particular, the computing apparatus 226, in particular the control device 228, controls the provision of the electron beam 202 by way of driving the electron column 210. In particular, the computing apparatus 226, in particular the control device 228, controls the scanning of the electron beam 202 over the surface of the photomask 100 by driving the scanning unit 216. Moreover, the computing apparatus 226 controls the provision of the process gas by driving the gas provision unit 220.

Moreover, the computing apparatus 226 receives measured data from the detector 218 and/or other detectors of the apparatus 200 and produces images from the measured data, which images can be displayed on a monitor (not shown here). Moreover, images produced from the measured data can be stored in a memory unit (not shown here) of the computing apparatus 226.

To check the photomask 100 and, in particular, the structured coating 104 on the photomask 100, the apparatus 200 is configured, in particular, to capture an image 300 of the photomask 100 (FIG. 1) or an image 3X) of a detail of the photomask 100 from measured data from the detector 218 and/or other detectors of the apparatus 200. By way of example, a spatial resolution of the image 300 is of the order of a few nanometers.

The computing apparatus 226, in particular the determination device 230, is configured to recognize a defect D (FIG. 1) in the recorded image 300, to locate said defect and to determine a geometric shape 302 (repair shape 302) of the defect D. The determined geometric shape 302 of the defect D, that is to say the repair shape 302, is a two-dimensional geometric shape for example.

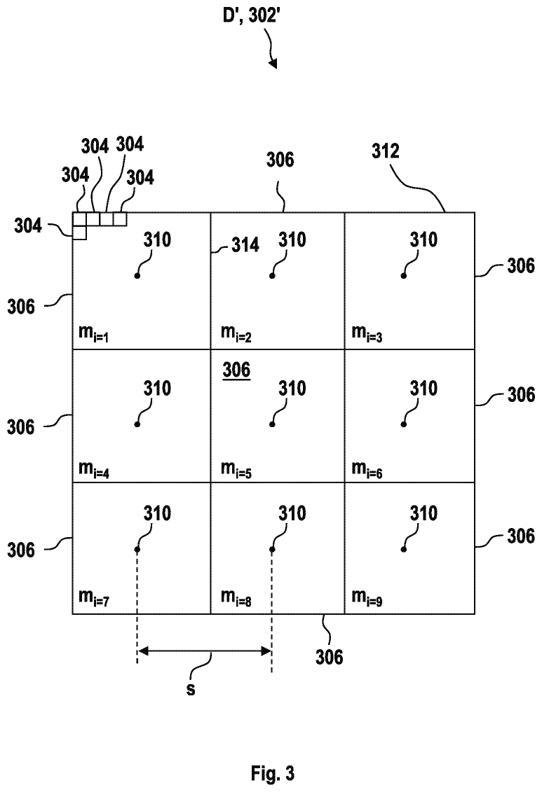

FIG. 3 shows a further example of a defect D′ of a structured coating 104 of the photomask 100. In this example, the defect D′, and hence its repair shape 302′, is square.

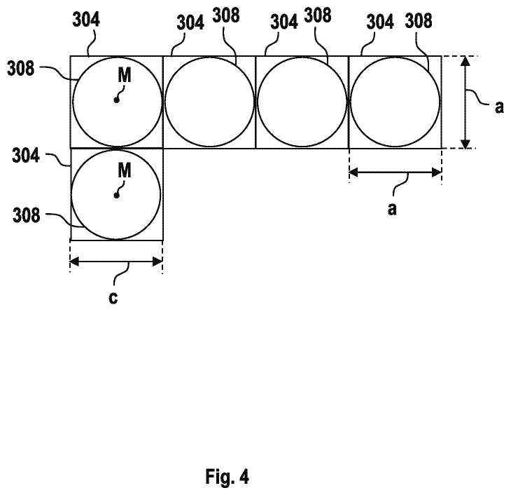

The computing apparatus 226, in particular the determination device 230, is configured to divide the repair shape 302, 302′ (FIGS. 1 and 3) into a grid comprising a number n of pixels 304. FIG. 3 plots a few pixels 304 of the repair shape 302′ in exemplary fashion. By way of example, the repair shape 302′ comprises 1 million pixels 304 (n=1 000 000). By way of example, a side length a (FIG. 4) of the pixels 304 is a few nanometers, for example 1.5 nm. By way of example, the pixels 304 have a size of 1.5 nm×1.5 nm. During the course of a repair method, the electron beam 202 is directed at each center of each pixel 304 multiple times by use of the scanning unit 216. In particular, an intensity maximum of the Gaussian intensity profile of the electron beam 202 is directed at each center of each pixel 304 multiple times over the course of the method.

The computing apparatus 226, in particular the subdivision device 232, is configured to subdivide the repair shape 302, 302′ into a plurality, in particular into a number k, of sub-repair shapes 306, for example on the basis of a threshold W. By way of example, the computing apparatus 226 is configured to subdivide the repair shape 302, 302′ if the number n of pixels 304 of the repair shape exceeds a predetermined threshold W. By way of example, the total number k of sub-repair shapes into which a given repair shape 302′ is subdivided is defined in advance on the basis of a predetermined threshold W. By way of example, the predetermined threshold W is a threshold W that has been determined empirically.

In the example shown in FIG. 3, the repair shape 302′ is subdivided into nine sub-repair shapes 306 (k=9). Each sub-repair shape 306 has a number mᵢ of pixels 304, which are a subset of the n pixels 304 of the repair shape 302′. In particular, the summation over mᵢ for i=1 to k equals n. In the example shown in FIG. 3, the sub-repair shapes 306 all have the same size. Expressed differently, each of the nine sub-repair shapes 306 comprises the same number mᵢ of pixels 304 (i.e. m_{i(i=1 to 9)}=n/k). In other examples, the number mᵢ of pixels 304 of an i-th sub-repair shape 306 may also differ from one, some or all other (k−1) sub-repair shapes 306.

FIG. 4 shows a magnified detail from FIG. 3, in which the five pixels 304 of the first sub-repair shape 306 shown in exemplary fashion in FIG. 3 are depicted in magnified fashion. Each pixel 304 is square with a side length a. Consequently, the distance between two adjacent pixel centers M also equals a. The circles with diameter c and denoted by the reference signs 308 represent areas of incidence of the electron beam 202 on the surface of the photomask 100. In this case, the diameter c corresponds to the side length a. The electron beam 202 has a radially symmetric Gaussian intensity profile in particular. In particular, the electron beam 202 is directed at a center M of the area of incidence 308 or of the pixel 304 such that a maximum of the intensity distribution thereof is incident on the center M within the scope of what is technically possible. By way of example, the areas of incidence 308 may correspond to a full width at half maximum of the intensity profile of the electron beam 202. However, the areas of incidence 308 may also correspond to any other intensity drop from the maximum of the intensity distribution of the electron beam 202.

By way of example, the repair shape 302′ (FIG. 3) is subdivided into the k sub-repair shapes 306 by use of a Voronoi approach (Voronoi diagram). In this case, the computing apparatus 226, in particular the subdivision device 232, is used to define a distance s between Voronoi centers 310 in the repair shape 302′ (FIG. 3). Voronoi centers (310) in the repair shape 302′ are determined on the basis of this distance s using the computing apparatus 226, in particular the subdivision device 232.

Furthermore, the computing apparatus 226, in particular the subdivision device 232, is configured in this example to determine the sub-repair shapes 306 as Voronoi regions starting from the Voronoi centers 310. Hence, each sub-repair shape 306 determined thus comprises the pixel 304 of the repair shape 302′ corresponding to the associated Voronoi center 310 and all pixels 304 of the repair shape 302′ that are arranged closer to the associated Voronoi center 310 than any other Voronoi center 310 of the repair shape 302′.

While FIG. 3 shows a relatively simple repair shape 302′, specifically a square, even complex repair shapes can be suitably subdivided into sub-repair shapes by use of a Voronoi approach. Examples in this respect include honeycomb structures or more general two-dimensional polyhedra.

The computing apparatus 226, in particular the control device 228, is configured to scan the repair shape 302′, which has been subdivided into the sub-repair shapes 306, by use of the electron beam 202 and under the provision of the process gas so that the defect D′, the geometric shape of which is the repair shapes 302′, is processed and rectified. In this case, the activating electron beam 202 is successively directed at each of the mᵢ₌₁ pixels 304 of the first sub-repair shape 306. The electron beam 202 dwells at each of the mᵢ₌₁ pixels 304 of the first sub-repair shape 306 for a predetermined dwell time. In this case, a chemical reaction of the process gas is activated at each of the mᵢ₌₁ pixels 304 of the first sub-repair shape 306 by way of the electron beam 202. By way of example, the process gas comprises an etching gas. By way of example, the chemical reaction leads to volatile reaction products with the material of the defect D′ to be etched arising, which are at least partly gaseous at room temperature and which can be pumped away using a pump system (not shown).

After the electron beam 202 has been directed at each of the mᵢ₌₁ pixels 304 of the first sub-repair shape 306 once (step d)), this procedure is repeated over a number j of repetition cycles (step e)).

After the first sub-repair shape 306 has been processed over a number j of repetition cycles at all mᵢ₌₁ pixels 304 of the first sub-repair shape 306, each further one of the remaining k−1 sub-repair shapes 306 of the repair shape 302′ is processed accordingly (step f)). In this case, the sequence in which the sub-repair shapes 306 are processed may differ from a line-by-line and/or column-by-column sequence. Expressed differently, in the example of FIG. 3, the sub-repair shapes 306 may also be processed in a different sequence to sequentially from top left to bottom right. By way of example, a sequence in which the sub-repair shapes 306 are processed may be randomly distributed.

In embodiments, steps d) to f) are repeated over a number p of repetition cycles so that the overall number of repetition cycles for each of the mᵢ₌₁ pixels 304 is j×p.

To (completely) remove the coating 104 in the region of the defect D′, a number j (or j×p) of repetition cycles totaling 100, 1000, 10 000, 100 000 or one million, for example, are required at each pixel mᵢ₌₁.

Since the repair shape 302′, which has n pixels, is subdivided into the plurality of sub-repair shapes 306 (k sub-repair shapes 306, nine in this case), which each have n/k pixels in the example of FIG. 3, a processing time for one of the k sub-repair shapes 306 is shorter than the processing time for the entire repair shape 302′. This is advantageous since a gas composition of the process gas which is required and/or optimal for processing of the defect D′ can be better ensured during the processing of a sub-repair shape 306. By way of example, the gas composition of the process gas can be renewed for each sub-repair shape 306 rather than for each repair shape 302′. By way of example, this can avoid a significant reduction in an etching rate on account of a disadvantageous gas composition of the process gas.

Unwanted phenomena may arise in boundary regions 314 between the sub-repair shapes 306 in the case of the subdivision 312 of the repair shape 302′ into the sub-repair shapes 306 shown in FIG. 3 and the described scanning method by use of the electron beam 202. By way of example, a boundary region 314 between the first sub-repair shape 306 and the second sub-repair shape 306 has been provided with a reference sign in FIG. 3. In such boundary regions 314, processing by use of the electron beam 202 may lead to an excessive or insufficient material ablation or to an excessive or insufficient deposition of material.

To avoid such intra-repair shape artefacts, the computing apparatus 226, in particular the subdivision device 232, may be configured to subdivide the repair shape 302′ into a number h of mutually different subdivisions 312, 316.

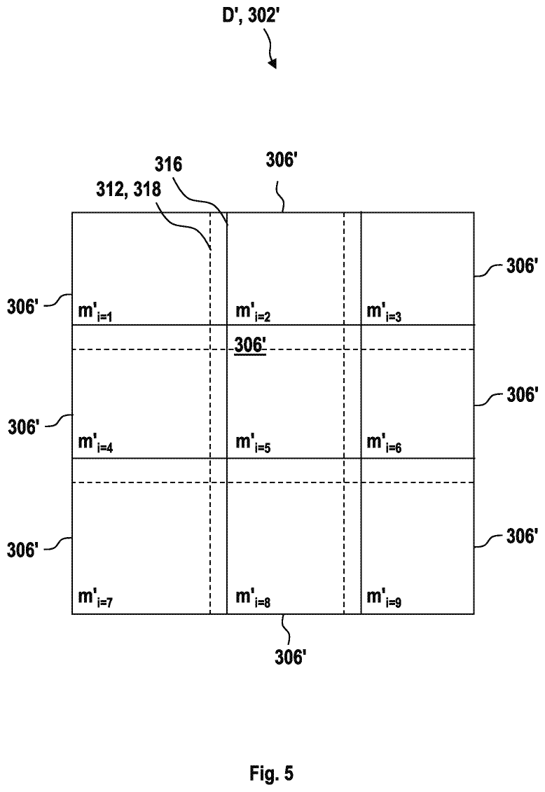

FIG. 5 shows a view similar to FIG. 3, with the subdivision 312 of the repair shape 302′ into the sub-repair shapes 306 shown in FIG. 3 being depicted in FIG. 5 using dashed lines. Moreover, FIG. 5 shows a further subdivision 316 calculated by the computing apparatus 226, in particular the subdivision device 232. Consequently, FIG. 5 elucidates a subdivision of the repair shapes 302′ into two mutually different subdivisions 312, 316.

In the example shown in FIG. 5, the subdivision 316 differs from the subdivision 312 in that boundaries 318 of the sub-repair shapes 306 according to the first subdivision 312 were displaced laterally relative to the repair shape 302′ so that new sub-repair shapes 306′ were determined in this way. As is evident in FIG. 5, the sub-repair shapes 306′ according to the second subdivision 316 have different sizes from one another and different numbers m′ᵢ of pixels from one another.

If a plurality of subdivisions 312, 316 (h subdivisions, in this case two) are calculated for a repair shape 302′ for the purposes of avoiding intra-repair shape artefacts, then, for example, a predetermined number j (or j×p) of repetition cycles are divided among the plurality of subdivisions 312, 316. By way of example, in the example of FIG. 5, each sub-repair shape 306 of the first subdivision 312 and each sub-repair shape 306′ of the second subdivision 316 is processed by the electron beam 202 over a number g of repetition cycles, where g in each case equals j/h (or (j×p)/h). Expressed differently, the predetermined number j (or j×p) of repetition cycles is divided uniformly among the two subdivisions 312, 316.

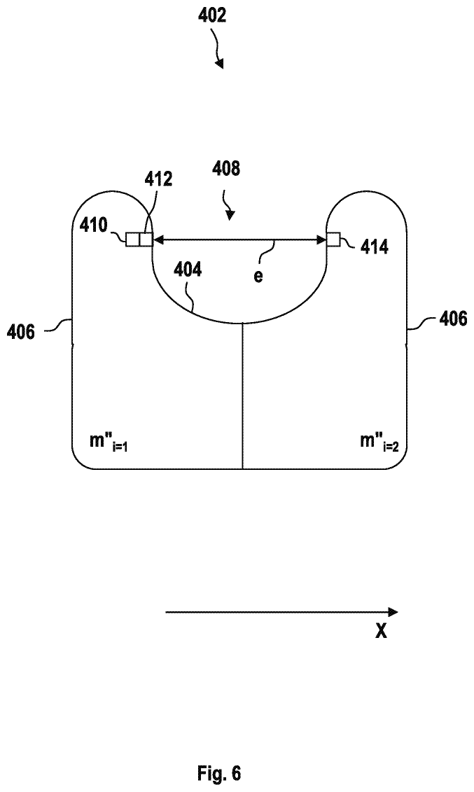

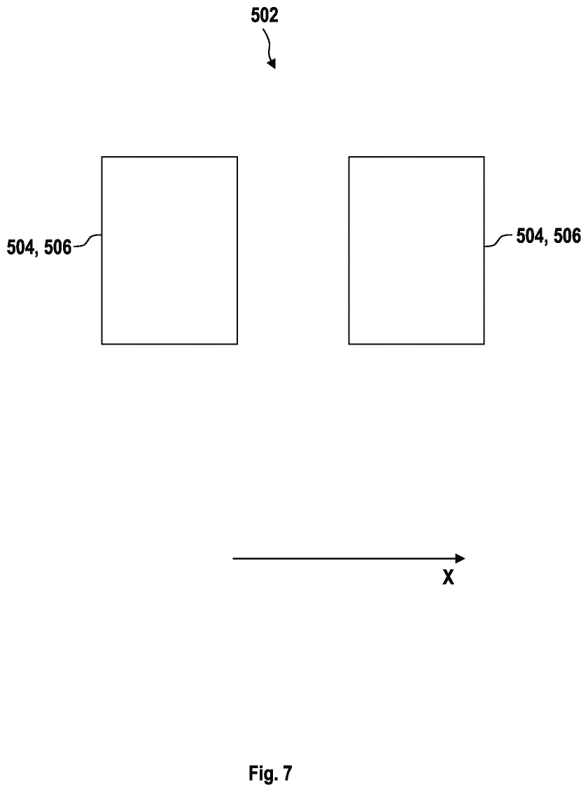

In the case of more complex repair shapes, the computing apparatus 226, in particular the subdivision device 232, can be configured to carry out the subdivision of the repair shapes while taking account of further boundary conditions, as elucidated in FIGS. 6 and 7.

FIG. 6 shows a further example of a repair shape 402. The repair shape 402 has a concave region 404 such that the electron beam 202 of the apparatus 200 would repeatedly in a scanning direction X traverse a gap 408 existing within the concave region 404. In such a case, the computing apparatus 226, in particular the subdivision device 232, may be configured to subdivide the repair shape 402 into a plurality of sub-repair shapes 406 so that the m″ᵢ pixels of a respective sub-repair shape 406 have the same distance from one another in the scanning direction X. Expressed differently, the repair shape 402 is subdivided into the plurality of sub-repair shapes 406 in such a way that the electron beam 202 need not traverse a gap when processing a sub-repair shape 406 in the scanning direction X.

Three pixels 410, 412, 414 of the repair shape 402 are plotted in FIG. 6 in exemplary fashion. The pixels 410 and 412 belong to the first sub-repair shape 406 and the pixel 414 belongs to the second sub-repair shape 406. It is evident that the two pixels 410 and 412 of the first sub-repair shape 406 are arranged directly next to one another. In particular, there is no gap therebetween, not even in the scanning direction X. By contrast, the pixel 412 of the first sub-repair shape and the pixel 414 of the second sub-repair shape are not arranged directly next to one another and there is a distance e, which corresponds to the gap 408, between them in the scanning direction X.

FIG. 7 shows a further example of a repair shape 502. In the example, the repair shape 502 has two spaced apart regions 504. The repair shape 502 may also have more than two spaced apart regions 504 in other examples. To subdivide the repair shape 502, the computing apparatus 226, in particular the subdivision device 232, may be configured to subdivide the repair shape 502 into a plurality of sub-repair shapes 506, in such a way that each sub-repair shape 506 comprises at most one of the two spaced apart regions 504. Expressed differently, the repair shape 502 is subdivided into the plurality of sub-repair shapes 506 in such a way that the electron beam 202 need not traverse a gap in the scanning direction X when processing a sub-repair shape 506.

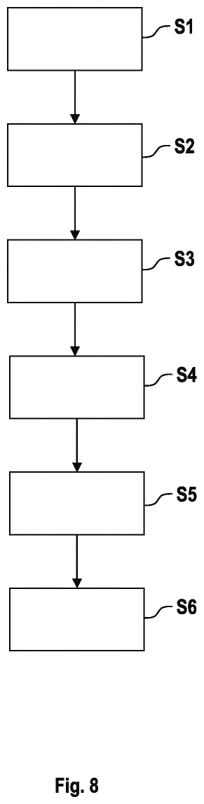

FIG. 8 shows a flowchart of a method for particle beam-induced processing of a defect of a microlithographic photomask. A defect D, D′ of a photomask 100 (FIG. 1) can be processed by use of the method. By way of example, the defect D, D′ has a repair shape 302 as shown in FIG. 1, a repair shape 302′ as shown in FIG. 3, a repair shape 402 as shown in FIG. 6, a repair shape 502 as shown in FIG. 7 or any other repair shape.

In step S1 of the method, an image 300 of at least a portion of the photomask 100 is provided. In particular, a scanning electron microscope image 300 of a portion of the photomask 100 is captured by use of the apparatus 200, a defect D, D′ of a structured coating 104 of the photomask 100 being imaged in said image.

In step S2 of the method, a geometric shape of the defect D, D′ in the image 300 is determined as a repair shape 302, 302′, 402, 502.

In step S3 of the method, the repair shape 302, 302′, 402, 502 is subdivided into a plurality of sub-repair shapes 306, 406, 506 in computer-implemented fashion. By way of example, this subdivision is implemented on the basis of a threshold W (e.g., an empirically determined threshold).

In step S4 of the method, an activating particle beam 202 and a process gas are provided at each pixel of a first of the sub-repair shapes 306, 406, 506.

In step S5 of the method, step S4 is repeated for the first of the sub-repair shapes over a number j of repetition cycles.

In step S6 of the method, steps S4 and S5 are repeated for each further one of the sub-repair shapes.

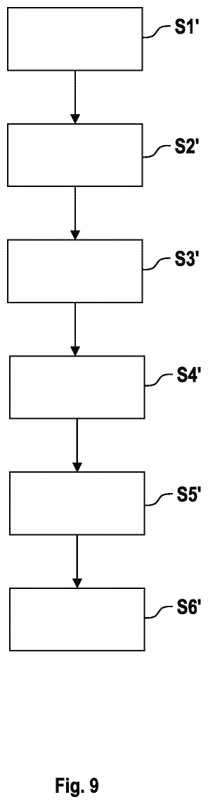

In embodiments, a method is carried out for determining the threshold W, as illustrated in FIG. 9 by a flowchart. In particular, this method is carried out before the above-described method for particle beam-induced processing of a defect of a microlithographic photomask (FIG. 8). The method according to FIG. 9 is, in particular, a method for empirically determining the threshold W.

In the example of a method for determining the threshold W described in relation to FIG. 9, the determined threshold W is a repair shape size G_{S} (FIG. 11), i.e. a defect size. In particular, the threshold W in this example has a maximum repair shape size G_{S}. The repair shape size G_{S} can be specified in units of area or as a number of pixels.

In other examples the threshold W may additionally also have a minimum repair shape size. Expressed differently, the threshold W may also exhibit a range of a repair shape size with a lower limit (minimum repair shape size) and an upper limit (maximum repair shape size).

In other embodiments of the method for determining the threshold, the threshold W may also be a different parameter to a repair shape size G_{S}.

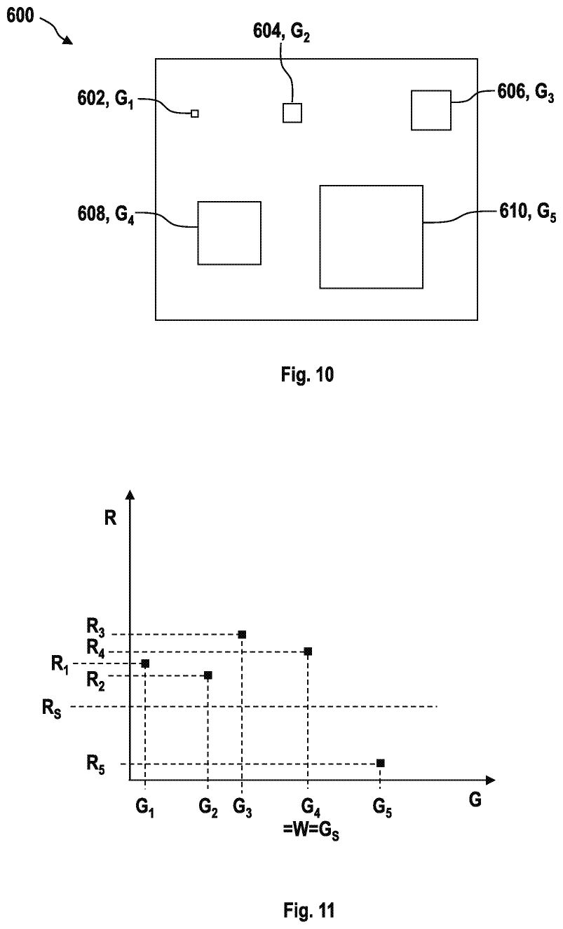

The threshold W is determined in the method of FIG. 9 such that when the determined threshold W is applied to the repair method of FIG. 8, a defect D or D′ (FIG. 1 or 3) of a photomask 100 can be repaired, e.g. etched, by particle beam-induced processing to at least a specified quality. In the method for determining the threshold W of FIG. 9, test defects 602 to 610 (FIG. 10) that are similar to the defect D or D′ of the photomask 100 in FIG. 1 or FIG. 3 are repaired for testing purposes by way of particle beam-induced processing, for example using the apparatus 200 (FIG. 2). The quality of the repair is then determined.

By way of example, the quality of the repair is determined by detecting the smoothness of etching, the width of etching edges and/or the speed of the etching. The quality is dependent on various parameters that are adjustable by use of the apparatus 200 (FIG. 2), for example on the dwell time of the electron beam 202 (FIG. 2) on a pixel 304 (FIG. 3), the pause between the exposure of one pixel 304 and a further pixel 304, the type of guidance of the electron beam 202 (scanning) over the pixels 304 of the repair shape 302′ (e.g. line scan or randomized homing in on the pixels) and the gas quantity flow rate (flow rate) of the process gas. Moreover, the quality of the repair depends on the type of mask material of the photomask (e.g. photomask 100 in FIG. 1) and the selected process gas (e.g. process gas mixture). Moreover, the quality of the repair depends on the repair shape to be repaired (for example, repair shape 302, 302′, 402, 502 in FIGS. 1, 3, 6, 7). In particular, the quality of the repair depends on the repair shape size (defect size) and—should the repair shape be subdivided into a plurality of sub-repair shapes (e.g. 306 in FIG. 3)—also on the size of these sub-repair shapes.

In the example of a method for determining the threshold W described in relation to FIG. 9, a first test defect (e.g. test defect 606 in FIG. 10) (similar to defect D or D′ of the photomask 100 in FIG. 1 or FIG. 3) is repaired, e.g. etched, by use of particle beam-induced processing using the apparatus 200 in step S1′, for a given mask material (e.g. the mask material of the photomask 100 in FIG. 1) and for a first given defect size (e.g. a typical or mean defect size G₃, for example with a size of 300×400 nm²).

In this case, the following repair parameters which can be adjusted by use of the apparatus 200 are set:
i) a dwell time of the electron beam 202 on a pixel (for example 100 ns, 10 ns or a few μs),
ii) a pause during which no pixel is “exposed” by the electron beam 202 in order to ensure that sufficient adsorbed process gas is present at the surface near the repair site again (e.g., a value between 100 μs and 5000 μs),
iii) a type of guidance (scanning) of the electron beam 202 over the pixels of the repair shape, e.g. line scan, serpentine scan, randomized homing in on the pixels and/or incremental homing in on the pixels (by way of example, every x-th pixel is homed in on first, followed by the not yet “exposed” pixels), and
iv) a gas quantity flow rate of the process gas (by way of example, the gas quantity flow rate is defined by setting the temperature of the process gas, the temperature for example being between −40° C. and +20° C.).

FIG. 10 shows an image 600 (e.g., an SEM image) of a plurality of repaired test defects 602, 604, 606, 608 and 610. The test defects 602 to 610 accordingly have different sizes G₁ to G₅. By way of example, the sizes G₁ to G₅ are specified as a number of pixels. By way of example, the test defect 602 has a size G₁ of 2500 pixels, the test defect 604 has a size G₂ of 40 000 pixels, the test defect 606 has a size G₃ of 160 000 pixels, the test defect 608 has a size G₄ of 360 000 pixels and the test defect 610 has a size G₅ of 1 000 000 pixels.

However, the size of the test defects 602 to 610 may also be specified in other units to pixels in other examples. Furthermore, the test defects 602 to 610 may also have different sizes G₁ to G₅ to the sizes specified in exemplary fashion. FIG. 10 furthermore shows five test defects 602 to 610 in exemplary fashion but it is also possible to apply more than or fewer than five test defects within the scope of the method for determining the threshold.

The first test defect which is repaired, e.g. etched, in step S1′ by use of particle beam-induced processing with the apparatus 200 for testing purposes is e.g. the test defect 606, which has a mean size G₃. However, another one of the test defects 602 to 610 can be processed as first test defect in step S1′.

In step S2′ of the method for determining the threshold W, the quality of the repair, e.g. the etching, of the first test defect 606 processed in step S1′ is determined. By way of example, the quality of the repair is determined by determining the smoothness of the repair site (e.g. smoothness of etching), the width of repair edges (e.g. etching edges), the speed of the repair (e.g. etching) and/or the quantity of etched or deposited material (e.g. the etching rate or deposition rate).

FIG. 11 shows a diagram in which an etching rate R is plotted against defect size G. By way of example, an etching rate R₃ was determined in step S2 for the first test defect 606 with a size G₃.

Whether the quality of the repair of the first test defect 606 determined in step S2′ is better than or equal to a specified quality is determined in step S3 of the method for determining the threshold W. By way of example, there is a determination as to whether the detected etching rate R₃ of the repaired test defect 606 is sufficient. By way of example, there is a determination as to whether the detected etching rate R₃ is greater than a predetermined etching rate R_{S} (FIG. 11).

Steps S1′ to S3′ are repeatedly carried out until the quality of the repair determined in step S3′ is better than or equal to the specified quality. In particular, the parameters set in step S2′ are varied in the process in order to determine the optimal parameter settings for the specified quality.

In step S4′ of the method for determining the threshold W, a test series for different defect sizes—for example for the test defects 602 to 610, shown in FIG. 10, with the sizes G₁ to G₅—is carried out using the optimal parameter settings determined in steps S1′ to S3′ for the first test defect (e.g. 606, FIG. 10). In particular, the test series is carried out for defect sizes (e.g. G₁, G₂, G₄ and G₅) of further test defects 602, 604, 608 and 610 which differ from the first specified defect size (e.g. G₃). Within the scope of the test series, the further test defects 602, 604, 608 and 610 are repaired, e.g. etched, by use of particle beam-induced processing.

In step S5′ of the method for determining the threshold W, the quality of the repair is determined for each defect size G₁, G₂, G₄ and G₅ applied in step S4′ (i.e. for each test defect 602, 604, 608 and 610 repaired in step S4′). By way of example, an etching rate R₁, R₂, R₄ and R₅ (FIG. 11) is determined for each repaired test defect 602, 604, 608 and 610.

As is evident from FIG. 11, the determined etching rates R₁ to R₄ for the test defects 602 to 608 (i.e. defect sizes G₁ to G₄) are relatively constant and, in particular, greater than the predetermined etching rate R_{S}. Expressed differently, an etching procedure for these test defects 602 to 608 was concluded with a sufficient result. However, the etching rate R₅ is substantially lower for the largest test defect 610 (defect size G₅) than for the other test defects 602 to 608 and, in particular, it is less than the predetermined etching rate R_{S}. Expressed differently, an etching procedure for this test defect 610 was concluded with an inadequate result.

In step S6′ of the method for determining the threshold W, the threshold W is determined on the basis of the result of the test series. By way of example, the threshold W is determined on the basis of the maximum defect size (G₄ in FIG. 11), for which the quality of repair determined in step S5′ is better than or equal to the specified quality. The threshold W can also be determined as the range of defect size (from minimum defect size Gₘᵢₙ to maximum defect size Gₘₐₓ, e.g. from G₁ to G₄ in FIG. 11) for which the quality of the repair is better than or equal to the specified quality.

By way of example, the threshold W can also be determined on the basis of the following equation:

W={x[(Gₘₐₓ)^{0.5}−−(Gₘᵢₙ)^{0.5}]⁵+(Gₘᵢₙ)^{0.5}}².

Here, x is a factor which is e.g. 0.5 or 0.75 or else 1. In the example of FIG. 11, Gₘₐₓ=G₄ and Gₘᵢₙ=G₁.

The threshold W determined in the above-described method (FIG. 9, steps S1′ to S6′) before the actual mask repair (FIG. 8, steps S1 to S6) can be used when performing the actual mask repair (FIG. 8). In particular, in step c) of the method for particle beam-induced processing of a defect (FIG. 8), the repair shape (302, 302′ in FIGS. 1 and 3, respectively) can be subdivided into sub-repair shapes (306 in FIG. 3) when the size of the defect to be processed is greater than the determined threshold W (e.g. greater than the threshold W determined by use of the aforementioned equation and/or greater than the maximum defect size Gₘₐₓ=G₄ for which the repair still is sufficient). Moreover, the number k of sub-repair shapes (306 in FIG. 3) into which the repair shape (302, 302′ in FIGS. 1, 3) is subdivided in step c) can be set on the basis of the threshold W in such a way that the size of each of the sub-repair shapes (306 in FIG. 3) is less than or equal to the determined threshold W and/or the size of each of the sub-repair shapes (306 in FIG. 3) is within the determined range of the defect size.

Although the present invention has been described on the basis of exemplary embodiments, it can be modified in various ways.

### LIST OF REFERENCE SIGNS

100 Photomask
102 Substrate
104 Coating
200 Apparatus
202 Particle beam
204 Vacuum housing
206 Vacuum pump
208 Sample stage
210 Electron column
212 Electron source
214 Electron or beam optics
216 Scanning unit
218 Detector
220 Gas provision unit
222 Valve
224 Gas line
226 Computing apparatus
228 Control device
230 Determination device
232 Subdivision device
300 Image
302, 302′ Repair shape
304 Pixel
306 Sub-repair shape
310 Voronoi center
312 Subdivision
314 Boundary region
316 Subdivision
318 Boundary
402 Repair shape
404 Concave region
406 Sub-repair shape
408 Gap
410 Pixel
412 Pixel
414 Pixel
502 Repair shape
504 Spaced apart regions
506 Sub-repair shape
600 Image
602 Test defect
604 Test defect
606 Test defect
608 Test defect
610 Test defect
a Pixel size
B Structure width
c Diameter
D, D′ Defect
e Distance
G Size
G₁ Size
G₂ Size
G₃ Size
G₄ Size
G₅ Size
G_{S} Size
M Center
R Etching rate
R₁ Etching rate
R₂ Etching rate
R₃ Etching rate
R₄ Etching rate
R₅ Etching rate
R_{S} Etching rate
s Distance
S1-S6 Method steps
S1′-S6′ Method steps
X Direction
W Threshold

What is claimed is:

1. A method for particle beam-induced processing of a defect of a microlithographic photomask, including the steps of:
a) providing an image of at least a portion of the photomask,
b) determining a geometric shape of a defect in the image as a repair shape, with the repair shape comprising a number n of pixels,
c) subdividing, in computer-implemented fashion, the repair shape into a number k of sub-repair shapes, with an i-th of the k sub-repair shapes having a number mᵢ of pixels, which are a subset of the n pixels of the repair shape,
d) providing an activating particle beam and a process gas at each of the mᵢ pixels of a first of the sub-repair shapes for the purposes of processing the first of the sub-repair shapes,
e) repeating step d) for the first of the sub-repair shapes over a number j of repetition cycles, and
f) repeating steps d) and e) for each further sub-repair shape.

2. The method of claim 1, wherein the activating particle beam and the process gas are solely provided at each of the mᵢ pixels of the first of the sub-repair shapes in step d).

3. The method of claim 1, wherein the repair shape is subdivided in step c) into the number k of sub-repair shapes on the basis of a threshold (W).

4. The method of claim 3, wherein the threshold (W) is an empirically determined value, which is determined before step a).

5. The method of claim 3, wherein the particle beam-induced processing comprises an etching of the defect or a deposition of material on the defect and the threshold (W) is determined from empirical values of an etching rate (R) or a deposition rate on the basis of a number n of pixels of a repair shape.

6. The method of claim 3, wherein the threshold (W) is an empirically determined value which is determined on the basis of parameters which are selected from a group comprising: the number n of pixels of the repair shape, a size of the pixels, an area of incidence of the particle beam, a dwell time of the activating particle beam on a respective pixel, a gas quantity flow rate with which the process gas is provided, a composition of the process gas and a gas quantity flow rate ratio of various gaseous components of the process gas.

7. The method of claim 1, wherein the repair shape is subdivided into the plurality of sub-repair shapes with the aid of a Voronoi approach.

8. The method of claim 7, wherein the sub-repair shapes are determined as Voronoi regions starting from Voronoi centers in step c), with each sub-repair shape comprising the pixel of the repair shape corresponding to the associated Voronoi center and all pixels of the repair shape that are arranged closer to the associated Voronoi center than any other Voronoi center of the repair shape.

9. The method of claim 1, wherein the repair shape is subdivided into the plurality of sub-repair shapes in such a way that the m″ᵢ pixels of a respective sub-repair shape have the same distance from one another in a scanning direction.

10. The method of claim 1, wherein the repair shape comprises at least two spaced apart regions and the repair shape is subdivided into the plurality of sub-repair shapes in such a way that each sub-repair shape comprises at most one of the at least two spaced apart regions.

11. The method of claim 1, wherein said method comprises the following step before step d): calculating a sequence in which the activating particle beam is successively provided at the mᵢ pixels of the first of the sub-repair shapes such that a depletion of the process gas by way of a chemical reaction activated by the activating particle beam is implemented uniformly over the sub-repair shape.

12. The method of claim 1, wherein the sequence in which steps d) and e) are carried out in step f) for the further sub-repair shapes differs from a row-by-row and/or column-by-column sequence and/or is randomly distributed.

13. The method of claim 1, wherein the repair shape is subdivided in a number h of mutually different subdivisions into sub-repair shapes in step c), and steps d) to f) are carried out for each of the h subdivisions.

14. The method of claim 13, wherein steps d) to f) are carried out for each of the h subdivisions over a number g of repetition cycles, where g is less than j, and/or over a number j/h of repetition cycles.

15. The method of claim 13, wherein the number h of subdivisions differ from one another by way of a displacement, in particular a lateral displacement, of boundaries of their sub-repair shapes relative to the repair shape.

16. The method of claim 1, wherein steps d) to f) are repeated over a number p of repetition cycles, and wherein p is an integer greater than or equal to two.

17. An apparatus for particle beam-induced processing of a defect of a microlithographic photomask, comprising:
means for providing an image of at least a portion of a photomask,
a computing apparatus for determining a geometric shape of a defect in the image as a repair shape, with the repair shape comprising a number n of pixels and being configured to subdivide the repair shape into a plurality of sub-repair shapes in computer-implemented fashion, and
means for providing an activating particle beam and a process gas at each pixel of every sub-repair shape over a number j of repetition cycles for processing the respective sub-repair shape.

18. A computer program product comprising instructions which, when executed by a computing apparatus for controlling an apparatus for particle beam-induced processing of a defect of a microlithographic photomask, prompt the apparatus to carry out the method steps of claim 1.

19. A method for determining a threshold (W) for subdividing a repair shape on the basis of the threshold (W) into a number k of sub-repair shapes during particle beam-induced processing of a defect of a microlithographic photomask, including the steps of
i) particle beam-induced processing of a first test defect of a photomask using predetermined processing parameters, the first test defect having a first size,
ii) determining a quality of the processing of the first test defect,
iii) repeating steps i) and ii) for modified processing parameters until processing parameters are determined, for which the determined quality is better than or equal to a predetermined quality,
iv) particle beam-induced processing of further test defects of the photomask using the determined processing parameters, with the further test defects each having a size that differs from the sizes of the other further test defects and from the size of the first test defect,
v) determining the quality of the processing for each further test defect, and
vi) determining the threshold (W) on the basis of the quality determined for the first and the further test defects.

20. The apparatus of claim 17, wherein the computing apparatus is configured to subdivide the repair shape in a number h of mutually different subdivisions into the sub-repair shapes, and
wherein the means for providing the activating particle beam and the process gas is configured to carry out providing the activating particle beam and the process gas at each pixel of every sub-repair shape over the number j of repetition cycles for processing the respective sub-repair shape for each of the h subdivisions.
